(19) United States
(12) Patent Application Publication
(10) Pub. No.: US 2017/0302421 A1
(43) Pub. Date: Oct. 19, 2017

(54) Signaling Enhancement for Fast Network Entry

(71) Applicant: MEDIATEK INC., Hsinchu (TW)

(72) Inventors: Chia-Chun Hsu, New Taipei City (TW); Per Johan Mikael Johansson, Kungsangen (SE)

(21) Appl. No.: 15/485,468

(22) Filed: Apr. 12, 2017

Related U.S. Application Data
(60) Provisional application No. 62/321,782, filed on Apr. 13, 2016.

(51) Int. Cl. H04L 5/00; H04W 74/08; H04W 72/04; H04W 12/08; H04W 76/02; H04W 74/00

(52) U.S. Cl. CPC H04L 5/0053; H04W 76/02; H04W 74/0833; H04W 74/004; H04W 12/08; H04W 72/042; H04W 72/0413; H04W 72/0446

(57) ABSTRACT

In order to establish a RRC connection and perform data transmission over an established DRB, a UE is required to complete a network entry procedure. For control plane latency (CPL), besides a random-access procedure, UE triggers two 3-way handshakes with eNB for RRC setup procedure and with MME for NAS setup procedure, which comprises a sequential execution of a list of individual signaling and processing. In one novel aspect, for latency reduction, the sequential execution is broken as to allow overlapping of the two procedures, e.g. lump RRC and NAS request under a new flexible RAN architecture, i.e. eNB/MME of the new RAT can be collocated. Lump request also requires certain SNR, so a big enough uplink grant can be scheduled. For the responses, out-of-sequence delivery is also possible as long as the execution dependency is clearly specified.

### CROSS REFERENCE TO RELATED APPLICATIONS

This application claims priority under 35 U.S.C. §119 from U.S. Provisional Application No. 62/321,782, entitled “Signaling Enhancement for Fast Network Entry,” filed on Apr. 13, 2016, the subject matter of which is incorporated herein by reference.

### TECHNICAL FIELD

The disclosed embodiments relate generally to network entry in mobile communication network, and, more particularly, to enhanced signaling for fast network entry and reduced control plane latency (CPL).

### BACKGROUND

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipments (UEs) over established radio resource control (RRC) connections and data radio bearers (DRBs). The radio access network further connects with a core network (CN), which includes Mobility Management Entity (MME), Serving Gateway (S-GW), and Packet Data Network Gateway (P-GW), to provide end-to-end services. In RRC CONNECTED mode, an eNB would keep UE's context (security, id) and process radio resource management (RRM) for that UE. RRM here includes data scheduling, link monitoring (MCS adaption), handover, etc. A UE is ensured to make seamless data transmission with eNB when the UE is in RRC_CONNECTED mode.

In order to establish a RRC connection and perform data transmission over an established DRB, a UE is required to complete a network entry procedure, which includes cell search procedure, system information decoding, and random access procedure. In addition, for control plane latency (CPL), besides random access procedure, the UE triggers two three-way handshaking processes with eNB and MME. A first three-way handshaking is the RRC handshaking, for setting up an RRC connection with eNB. A second three-way handshaking is the NAS handshaking, for setting up security and a DRB with MME.

An analysis of CPL involves breaking down the network entry, RRC setup, and NAS setup procedures into a sequential execution of a list of individual signaling and processing, and then adding up the total execution time in terms of the number of transmission time interval (TTI). For example, the number of TTIs for random access is estimated to be 10.5 TTIs, the number of TTIs for RRC setup is estimated to be 29.5 TTIs, and the number of TTIs for NAS setup is estimated to be 35 TTIs. As a result, the number of total TTIs required for random access, RRC setup, and NAS setup is estimated to be 75 TTIs. If each TTI is 1 ms, then the CPL is estimated to be 75 ms. Although shorter TTI and processing time may help to reduce CPL, enhancement from the signaling procedure is desired to seek fundamental improvement.

### SUMMARY

In order to establish a radio resource control (RRC) connection and perform data transmission over an established data radio bearer (DRB), a user equipment (UE) is required to complete a network entry procedure. For control plane latency (CPL), besides a random-access procedure, the UE triggers two 3-way handshakes with a base station (eNB) for RRC setup procedure and with a mobility management entity (MME) for NAS setup procedure, which comprises a sequential execution of a list of individual signaling and processing. In accordance with one novel aspect, for latency reduction, the sequential execution is broken as to allow overlapping of the RRC and the NAS procedures, e.g. to lump RRC request and NAS request under a new flexible radio access network (RAN) architecture, i.e. eNB and MME of the new radio access technology (RAT) can be collocated. The lump request also requires certain signal to noise ratio (SNR), such that a big enough uplink (UL) grant can be scheduled. For the responses, out-of-sequence delivery is also possible as long as the execution dependency is clearly specified. Without the lump request signaling, the total number of transmission time intervals (TTIs) required for random access, RRC setup, and NAS setup is estimated to be 75 TTIs. With the lump request signaling, however, it is possible to reduce the total number of TTIs required for the network entry procedure to about 34 TTIs.

In one embodiment, a user equipment (UE) performs a random-access procedure with a base station (eNB) in a mobile communication network. The UE transmits a lump request indication that indicates a subsequent lump request to setup a radio resource control (RRC) connection and a data radio bearer (DRB) with the network. The UE prepares a RRC request and a non-access stratum (NAS) request to be sent to the base station upon receiving an uplink grant for the lump request. The UE receives a plurality of eNB responses including an RRC setup, security information, and a DRB setup from the base station. Finally, the UE transmits one or more UE responses back to the base station in response to each of the plurality of eNB responses received from the base station.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network with enhanced signaling for control plane latency (CPL) reduction in accordance with one novel aspect.

FIG. 2 is a simplified block diagram of a UE and an eNodeB that carry out certain embodiments of the present invention.

FIG. 3 illustrates a first embodiment of signaling enhancement with lump request indicated by preamble in accordance with one novel aspect.

FIG. 4 illustrates a second embodiment of signaling enhancement with lump request indicated by Msg3 in accordance with one novel aspect.

FIG. 5 illustrates a third embodiment of signaling enhancement with lump request and context fetch in accordance with one novel aspect.

FIG. 6 is a flow chart of a method of signaling enhancement with lump request to reduce control plane latency in accordance with one novel aspect.

### DETAILED DESCRIPTION

Reference will now be made in detail to some embodiments of the invention, examples of which are illustrated in the accompanying drawings.

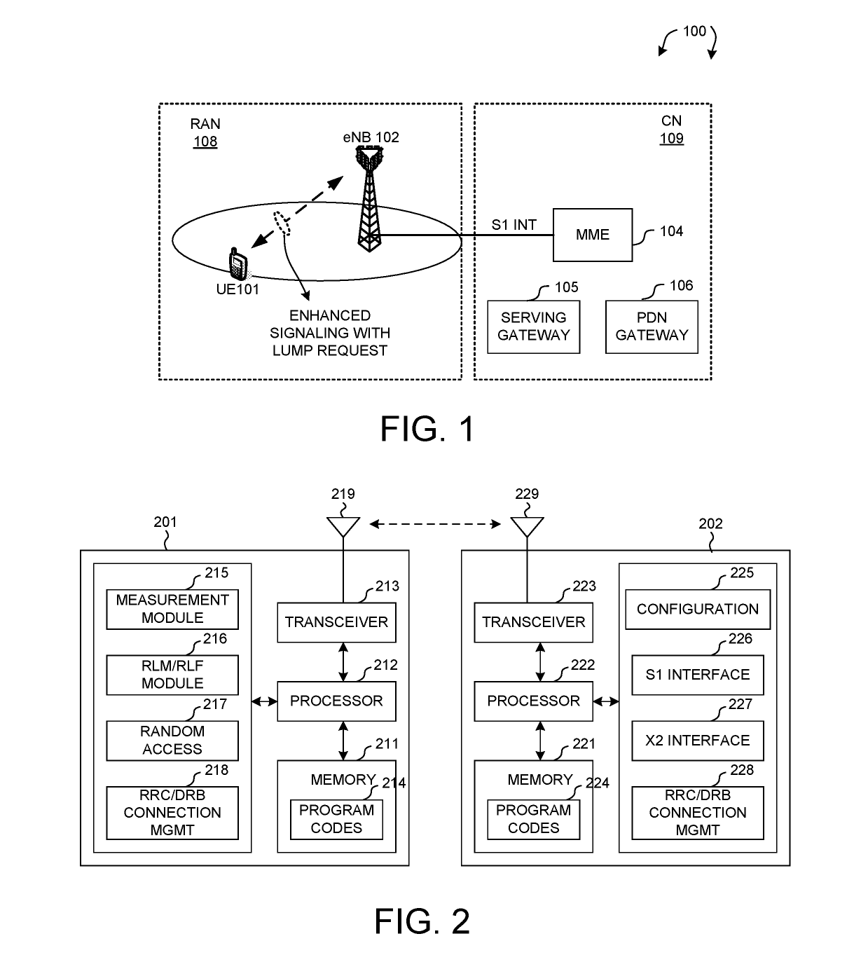

FIG. 1 illustrates a mobile communication network 100 with enhanced signaling for control plane latency (CPL) reduction in accordance with one novel aspect. Mobile communication network 100 comprises a user equipment UE 101, a radio access network (RAN) 108 having a base station eNB 102, and a packet core network (CN) 109 having a mobility management entity MME 104, a serving gateway SGW 105, and a packet data network (PDN) gateway PGW 106. The base stations communicate with each other via the X2 interface (not shown), and eNB 102 communicates with MME 104 via the S1 interface. UE 101 can access application servers through the radio access network RAN 108 and the packet core network CN 109.

In order to establish a radio resource control (RRC) connection and perform data transmission over an established data radio bearer (DRB), UE 101 is required to complete a network entry procedure, which includes cell search procedure, system information decoding, and random access procedure. For control plane latency (CPL), besides random access procedure, UE 101 triggers two three-way handshaking processes with eNB 102 and MME 104. A first three-way handshaking is the RRC handshaking, for setting up an RRC connection with eNB 102. A RRC request message is sent by UE 101 to establish a RRC connection with a signaling radio bearer (SRB). A second three-way handshaking is the NAS handshaking, for setting up security and a DRB with MME 104. A NAS request message is sent by UE 101 to establish a NAS signaling connection with a data radio bearer (DRB).

An analysis of CPL involves breaking down the network entry, RRC setup, and NAS setup procedures into a sequential execution of a list of individual signaling and processing, and then adding up the total execution time in terms of the number of transmission time interval (TTI). Although shorter TTI and processing time may help to reduce CPL, enhancement from the signaling procedure is desired to seek fundamental improvement. In accordance with one novel aspect, for latency reduction, the sequential execution can be broken as to allow overlapping of the RRC and NAS procedures. For example, lump RRC and NAS request can be made possible under the new flexible RAN architecture, i.e. eNB/MME of the new RAT can be collocated. Lump request also requires certain SNR, so a big enough uplink grant can be scheduled. For the responses, out-of-sequence delivery is also possible as long as the execution dependency is clearly specified.

In the example of FIG. 1, UE 101 checks its channel condition and determines whether to trigger lump request to reduce CPL. For example, if UE 101 is in cell center with strong SNR, then lump request can be triggered. If UE 101 is at cell edge with poor SNR, then lump request will not be triggered. If lump request is indicated by UE 101, then eNB 102 grants sufficient uplink resource for the lump request. Upon receiving the lump request, multiple responses from eNB 102 are generated and transmitted and out-of-sequence delivery of the responses is possible. UE 101 does not need to reply one by one individually. Instead, UE 101 waits all responses and execute them in predefined order. Without the lump request signaling, the total number of transmission time intervals (TTIs) required for random access, RRC setup, and NAS setup is estimated to be 75 TTIs. With the lump request signaling, in one example, the total number of TTIs required for the network entry procedure is ˜34 TTIs.

FIG. 2 is a simplified block diagram of a user equipment UE 201 and a base station eNodeB 202 that carry out certain embodiments of the present invention. User equipment UE 201 comprises memory 211 having program codes and data 214, a processor 212, a transceiver 213 coupled to an antenna module 219. RF transceiver module 213, coupled with the antenna, receives RF signals from the antenna, converts them to baseband signals and sends them to processor 212. RF transceiver 213 also converts received baseband signals from the processor, converts them to RF signals, and sends out to antenna 219. Processor 212 processes the received baseband signals and invokes different functional modules and circuits to perform different features and embodiments in UE 201. Memory 211 stores program instructions and data 214 to control the operations of UE 201.

User equipment UE 201 also comprises various function circuits and modules including a measurement circuit 215 that performs various measurements based on measurement configurations, an RLM/RLF circuit 216 that performs radio link monitoring, radio link failure detection and handling, a random-access handling circuit 217 that performs random access for cell search, cell selection, system information decoding and random access, and an RRC/DRB connection management and handling circuit 218 that performs RRC connection setup procedure and NAS setup procedure. The different circuits and modules are function circuits and modules that can be configured and implemented by software, firmware, hardware, or any combination thereof. The function modules, when executed by the processors (e.g., via executing program codes 214 and 224), allow UE 201 and eNB 202 to perform enhanced network entry signaling and procedure. In one example, UE 201 triggers a lump request so that RRC request and NAS request can be lumped together and sent to eNodeB 202 for reduced control plane latency.

Similarly, base station eNodeB 202 comprises memory 221 having program codes and data 224, a processor 222, a transceiver 223 coupled to an antenna module 229. RF transceiver module 223, coupled with the antenna, receives RF signals from the antenna, converts them to baseband signals and sends them to processor 222. RF transceiver 223 also converts received baseband signals from the processor, converts them to RF signals, and sends out to antenna 229. Processor 222 processes the received baseband signals and invokes different functional modules and circuits to perform different features and embodiments in eNodeB 202. Memory 221 stores program instructions and data 224 to control the operations of eNodeB 202. Base station eNodeB 202 also comprises various function circuits and modules including a configuration module 225 that provides various configuration to UE 201, an S1 interface module 226 that manages communication with an MME in the core network, an X2 interface module 227 that manages communication with other base stations, and an RRC/DRB connection management and handling circuit 228 that performs RRC connection setup and NAS setup procedures and maintains RRC/DRB connection.

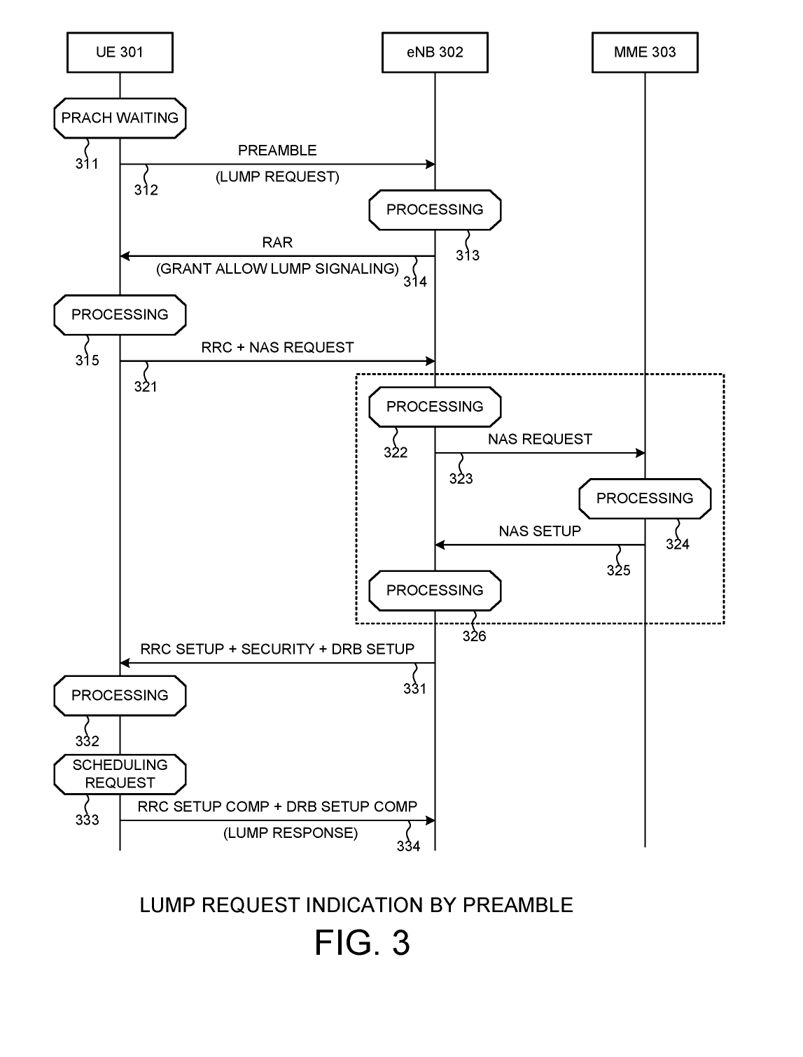

FIG. 3 illustrates a first embodiment of signaling enhancement with lump request indicated by preamble in accordance with one novel aspect. In step 311, UE 301 waits for the starting of a random-access procedure over a physical random access channel (PRACH), which may be triggered by an upper layer application. UE 301 also determines whether to indicate a lump request through the random-access procedure. The lump request can be triggered based on the following parameters: 1) whether channel condition is suitable for the lump request—e.g., whether the SNR indicates the UE is in good channel condition (cell center with strong SNR) or in bad channel condition (cell edge with poor SNR); 2) whether there is network support for the lump request—with broadcast indication from the network for UE in Idle mode or with dedicated signaling from the network for UE in the previous Connected mode (e.g., a cell list).

In step 312, UE 301 transmits a preamble to eNB 302 over the allocated PRACH radio resource. If the condition for lump request is met, then UE 301 indicates the lump request through the preamble over PRACH. The PRACH resource is selected from specific resource group configured by eNB 302. For example, the PRACH resource group can be PRACH preamble sequences or PRACH transmission slots. In step 313, eNB 302 receives and processes the preamble and the lump request. In step 314, eNB 302 transmits a random-access response (RAR) back to UE 301. The RAR includes an uplink grant that allows lump request signaling. The uplink grant allocates sufficient uplink radio resource for subsequent RRC request and NAS request. In step 315, UE 301 prepares both RRC request and NAS request in UE layer 2 buffer. Typically, a RRC request is a message to request the establishment of an RRC connection, which comprises a signaling radio bearer, RCL-SAP, logical channel and a direction (UE to E-UTRAN). A NAS request is a service request for requesting the establishment of a NAS signaling connection and of the radio and S1 bearers. A NAS request comprises information elements that includes a protocol discriminator, a security header type, KSI and sequence number, and message authentication code. Note that eNB 302 could grant multiple UL grants to receive the lump request. It is also possible that eNB 302 rejects the lump request by granting insufficient resource.

In step 321, UE 301 transmits the prepared RRC request and NAS request to eNB 302. In step 322, eNB 302 processes both RRC request and NAS request, which includes RRC setup. In step 323, eNB 302 forwards the NAS request to MME 303. In step 323, MME 303 processes the NAS request, which includes security and DRB setup. In step 325, MME 303 sends a NAS setup back to eNB 302. In step 326, eNB 302 processes the NAS setup message. In step 331, eNB 302 generates and transmits multiple responses to UE 301. Note that for flexible network architecture, MME function can be close to eNB function. In some scenario, MME and eNB can be collocated or implemented within the same physical device. As a result, the handshaking between eNB 302 and MME 303 is efficient. Further note that UE 301 does not need to wait for RRC setup complete and then send the NAS request. As a result, the processing of RRC setup and DRB setup can be performed in parallel by eNB and MME to reduce latency.

In step 331, multiple responses of the RRC setup and NAS setup are generated and transmitted to UE 301, including RRC setup, security, and DRB setup. Note that out-of-sequence delivery of the responses is possible. UE 301 does not need to reply one by one individually. Instead, in step 332, UE 301 waits all responses and executes them in a predefined order, which reduces signaling latency. In step 333, UE 301 prepares a lump response and requests uplink resource. In step 334, UE 301 sends the lump response including RRC setup complete and DRB setup complete to eNB 302. Alternatively, UE 301 may send multiple setup complete responses to eNB 302 in response to each of the responses from the base station. The decision of sending one lump response or sending multiple setup complete responses can be made by a default configuration or based on eNB configuration or other UE internal conditions.

Without lump request signaling, an analysis of CPL involves breaking down the network entry, RRC setup, and NAS setup procedures into a sequential execution of a list of individual signaling and processing, and then adding up the total execution time in terms of the number of transmission time interval (TTI). For example, the number of TTIs for random access is estimated to be 10.5 TTIs, the number of TTIs for RRC setup is estimated to be 29.5 TTIs, and the number of TTIs for NAS setup is estimated to be 35 TTIs. As a result, the number of total TTIs required for random access, RRC setup, and NAS setup is estimated to be 75 TTIs. With lump request signaling, the number of TTIs for random access is estimated to be 10.5 TTIs, the number of TTIs for both RRC setup and the NAS setup together is estimated to be 23.5 TTIs. As a result, the number of total TTIs required for random access, RRC setup, and NAS setup is estimated to be 34 TTIs.

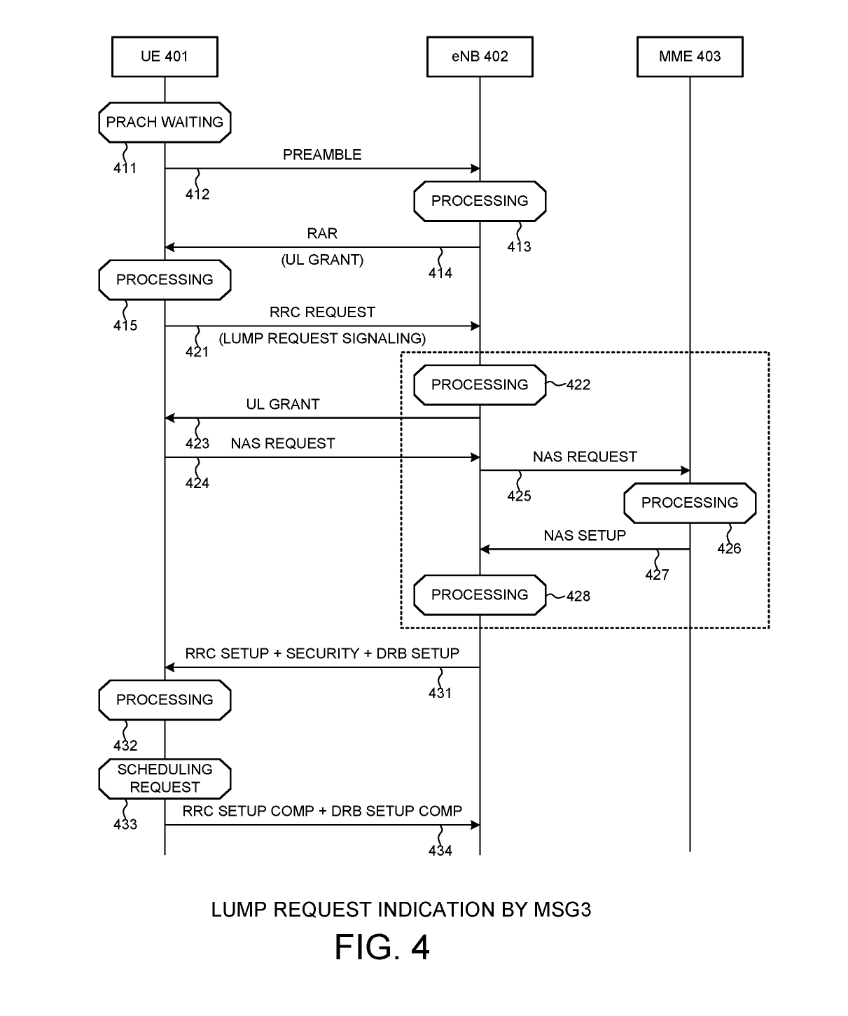

FIG. 4 illustrates a second embodiment of signaling enhancement with lump request indicated by Msg3 in accordance with one novel aspect. In step 411, UE 401 waits for the starting of a random-access procedure over a physical random access channel (PRACH), which may be triggered by an upper layer application. In step 412, UE 401 transmits a preamble to eNB 402 over the allocated PRACH radio resource. In step 413, eNB 402 receives and processes the preamble. In step 414, eNB 402 transmits a random-access response (RAR) back to UE 401. The RAR includes an uplink grant that allows subsequent RRC request. In step 415, UE 401 prepares RRC request in UE layer 2 buffer. If the condition for lump request is met, then UE 401 indicates a lump request through the subsequent RRC request.

In step 421, UE 301 transmits the prepared RRC request and the lump request indication to eNB 302. In step 422, eNB 302 processes the RRC request, which includes RRC setup. In step 423, eNB 402 allocates another uplink grant for subsequent NAS request. In step 424, UE 401 transmits the prepared NAS request to eNB 402. In step 425, eNB 402 forwards the NAS request to MME 303. In step 426, MME 303 processes the NAS request, which includes security and DRB setup. In step 427, MME 303 sends a NAS setup back to eNB 402. In step 428, eNB 302 processes the NAS setup message. In step 431, eNB 302 generates and transmits multiple responses to UE 401. Note although UE 401 transmits the RRC request and the NAS request separately, UE 401 does not need to wait for RRC setup complete and then send the NAS request. As a result, the processing of RRC setup and DRB setup can be performed in parallel by eNB and MME to reduce latency.

In step 431, multiple responses of the RRC setup and NAS setup are generated and transmitted to UE 401, including RRC setup, security, and DRB setup. Note that out-of-sequence delivery of the responses is possible. UE 401 does not need to reply one by one individually. Instead, in step 432, UE 401 waits all responses and executes them in a predefined order, which reduces signaling latency. In step 433, UE 401 prepares lump response and requests uplink resource. In step 434, UE 401 sends the lump response including RRC setup complete and DRB setup complete to eNB 402.

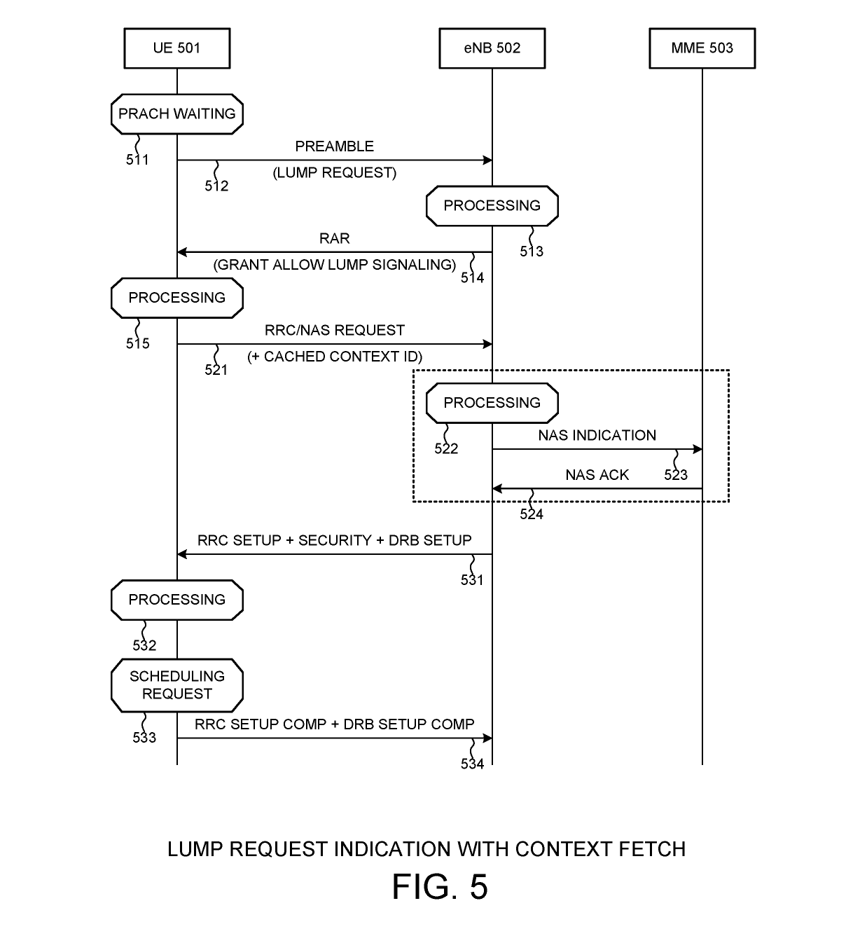

FIG. 5 illustrates a third embodiment of signaling enhancement with lump request and context fetch in accordance with one novel aspect. UE context is a block of information associated with one active UE. The block of information contains the necessary information required to maintain the E-UTRAN services towards the active UE. At least UE state information, security information, UE capability information and the identities of the UE connection/DRB are included in the UE context. The UE context is established when the transition to active state for a UE is completed or after a handover is completed. The eNB can cache the UE context, which can be fetched by the UE or other eNBs upon request. UE itself can also cache the UE context.

In step 511, UE 501 waits for the starting of a random-access procedure over a physical random access channel (PRACH), which may be triggered by an upper layer application. UE 501 also determines whether to indicate a lump request through the random-access procedure. In step 512, UE 501 transmits a preamble to eNB 502 over the allocated PRACH radio resource. If the condition for lump request is met, then UE 501 indicates the lump request through the preamble over PRACH. In step 513, eNB 502 receives and processes the preamble and the lump request. In step 514, eNB 502 transmits a random-access response (RAR) back to UE 501. The RAR includes an uplink grant that allows lump request signaling. The uplink grant allocates sufficient uplink radio resource for subsequent RRC request and NAS request. In step 515, UE 501 prepares both RRC request and NAS request in UE layer 2 buffer as well as a UE context ID.

In step 521, UE 501 transmits the prepared RRC request and NAS request to eNB 502. In accordance with one novel aspect, UE 501 also transmits the UE context ID to eNB 502. In step 522, eNB 502 processes both RRC request and NAS request, which includes RRC setup. Because the UE sends the eNB the UE context ID, in step 523, eNB 502 forwards a NAS indication if NAS update is needed to MME 503. The NAS indication is optional and is different from the NAS request. The NAS indication simply informs the MME that the UE is back to connected mode and the UE already has the UE context information with a corresponding UE context ID. As a result, the MME does not need to perform the NAS setup, which reduces the additional processing latency required for security and DRB setup. In step 524, MME 503 sends a NAS ACK back to eNB 502. In step 531, eNB 502 generates and transmits multiple responses to UE 501. Note that the context fetch mechanism can also be applied when the lump request indication is provided by the UE in Msg3, as illustrated in FIG. 4. For example, in FIG. 4, UE 401 could send its UE context ID to eNB 402 in step 421. As a result, UE 401 no longer needs to send the NAS request in step 424.

In step 531, multiple responses of the RRC setup and NAS setup are generated and transmitted to UE 501, including RRC setup, security, and DRB setup. Note that out-of-sequence delivery of the responses is possible. UE 501 does not need to reply one by one individually. Instead, in step 532, UE 501 waits all responses and executes them in a predefined order, which reduces signaling latency. In step 533, UE 501 prepares lump response and requests uplink resource. In step 534, UE 501 sends the lump response including RRC setup complete and DRB setup complete to eNB 502.

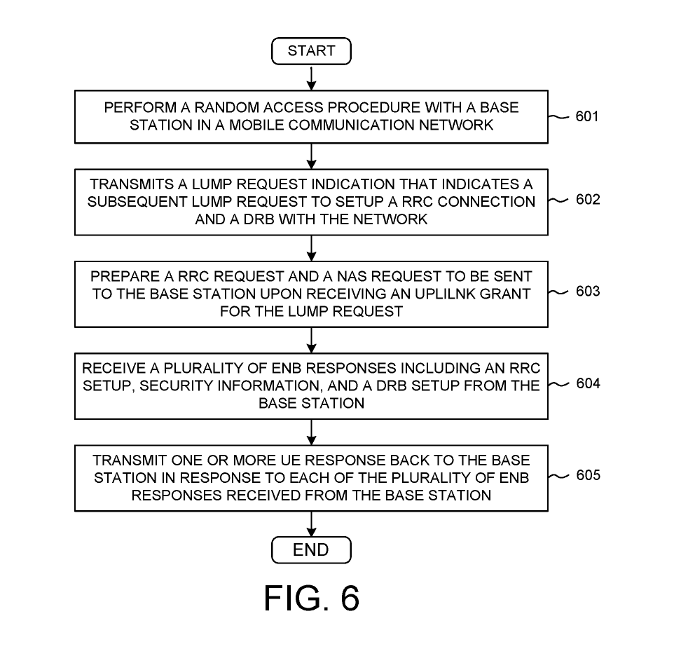

FIG. 6 is a flow chart of a method of signaling enhancement with lump request to reduce control plane latency in accordance with one novel aspect. In step 601, a user equipment (UE) performs a random-access procedure with a base station (eNB) in a mobile communication network. In step 602, the UE transmits a lump request indication that indicates a subsequent lump request to setup a radio resource control (RRC) connection and a data radio bearer (DRB) with the network. In step 603, the UE prepares a RRC request and a non-access stratum (NAS) request to be sent to the base station upon receiving an uplink grant for the lump request. In step 604, the UE receives a plurality of eNB responses including an RRC setup, security information, and a DRB setup from the base station. In step 605, the UE transmits one or more UE responses back to the base station in response to each of the plurality of eNB responses received from the base station.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
performing a random-access procedure by a user equipment (UE) with a base station (eNB) in a mobile communication network;
transmitting a lump request indication that indicates a subsequent lump request to setup a radio resource control (RRC) connection and a data radio bearer (DRB) with the network;
transmitting a RRC request and a non-access stratum (NAS) request to the base station upon receiving an uplink grant for the lump request;
receiving a plurality of eNB responses including an RRC setup, security information, and a DRB setup from the base station; and
transmitting one or more UE responses back to the base station in response to each of the plurality of eNB responses received from the base station.

2. The method of claim 1, further comprising:
determining a triggering condition for sending the lump request, wherein the triggering condition comprises at least a channel condition of the UE.

3. The method of claim 1, wherein the lump request indication is transmitted together with a preamble over a physical random access channel (PRACH).

4. The method of claim 3, wherein the PRACH resource is selected from a specific resource group configured by the base station for the lump request.

5. The method of claim 3, wherein the uplink grant schedules uplink radio resource for both the RRC request and the NAS request.

6. The method of claim 1, wherein the lump request indication is transmitted together with the RRC request after a random-access response.

7. The method of claim 1, wherein the UE sends a cached UE context ID together with the RRC request.

8. The method of claim 7, wherein the UE context ID indicates that the UE has UE context information that comprises UE identities of the RRC connection and the DRB, UE state information, security information, and UE capability information.

9. The method of claim 1, wherein the plurality of eNB responses is delivered to the UE out-of-sequence, and wherein the UE processes the plurality of responses in a predefined order.

10. The method of claim 1, wherein the one or more UE responses is a lump response based on a default configuration or an eNB configuration, or based on other UE internal conditions.

11. The method of claim 10, wherein the lump response comprises an RRC setup complete message and a DRB setup complete message.

12. A user equipment (UE), comprising:
a random-access handling circuit that performs a random-access procedure with a base station (eNB) in a mobile communication network;
a transmitter that transmits a lump request indication that indicates a subsequent lump request to setup a radio resource control (RRC) connection and a data radio bearer (DRB) with the network, wherein the UE also transmits one or more UE responses back to the base station;
a connection handling circuit that prepares a RRC request and a non-access stratum (NAS) request to be sent to the base station upon receiving an uplink grant for the lump request; and
a receiver that receives a plurality of eNB responses including an RRC setup, security information, and a DRB setup from the base station.

13. The UE of claim 12, wherein the UE determines a triggering condition for sending the lump request, wherein the triggering condition comprises at least a channel condition of the UE.

14. The UE of claim 12, wherein the lump request indication is transmitted together with a preamble over a physical random access channel (PRACH).

15. The UE of claim 14, wherein the PRACH resource is selected from a specific resource group configured by the base station for the lump request.

16. The UE of claim 14, wherein the uplink grant schedules uplink radio resource for both the RRC request and the NAS request.

17. The UE of claim 12, wherein the lump request indication is transmitted together with the RRC request after a random-access response.

18. The UE of claim 12, wherein the UE sends a cached UE context ID together with the RRC request.

19. The UE of claim 18, wherein the UE context ID indicates that the UE has UE context information that comprises UE identities of the RRC connection and the DRB, UE state information, security information, and UE capability information.

20. The UE of claim 12, wherein the plurality of eNB responses is delivered to the UE out-of-sequence, and wherein the UE processes the plurality of responses in a predefined order.

21. The UE of claim 12, wherein the one or more UE responses is a lump response based on a default configuration or an eNB configuration, or based on other UE internal conditions.

22. The UE of claim 21, wherein the lump response comprises an RRC setup complete message and a DRB setup complete message.
